(19) United States
(12) Patent Application Publication
(10) Pub. No.: US 2007/0228068 A1
(43) Pub. Date: Oct. 4, 2007

(54) Alcoholic beverage management and inventory system

(76) Inventors: Kevin Schneider, Orlando, FL (US); Bosko Lazic, Orlando, FL (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 11/549,020

(22) Filed: Oct. 12, 2006

Related U.S. Application Data
(60) Provisional application No. 60/725,848, filed on Oct. 12, 2005.

(51) Int. Cl. B67B 7/00

(52) U.S. Cl. 222/1

(57) ABSTRACT

An alcoholic beverage management and inventory system comprising a beverage bottle categorizing system; a weighing system for determining total liquor dispensed; a system for computing total profits earned or lost; a system and method for tracking the distribution and location of all bottles at any selected location within a bar establishment; and, an integrated data synchronization, transfer, processing, storage and retrieval system that enables real-time inventory management of any selected number of related and/or unrelated bar establishments.

### PRIORITY CLAIM TO RELATED APPLICATION

To the fullest extent permitted by law, the present nonprovisional patent application claims priority to and the full benefit of provisional patent application entitled “Alcoholic Beverage Management and Inventory System”, filed on Oct. 12, 2005, having assigned application Ser. No. 60/725,848.

### COPYRIGHT NOTICE

A portion of the disclosure of this patent document contains material which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### TECHNICAL FIELD

The present invention relates generally to inventory procedures, and more specifically to an alcoholic beverage management and inventory system designed to provide an interactive checks-and-balances system for tracking and monitoring alcohol purchase, shipment, receipt, and internal handling, distribution and dispensing practices. The present invention further provides, amongst other features, central data processing and network warehousing capabilities for contemporaneously managing and inventorying the alcohol supply, distribution and dispensing practices of multiple, independent and/or unrelated bars, clubs and restaurant.

### BACKGROUND OF THE INVENTION

Bars, clubs, and restaurants alike often suffer significant revenue loss due to employee liquor theft and from improper bartending practices that lead to accidental or intentional over-pouring of liquor to the establishments' patrons. Unfortunately, such activities are not limited to liquors alone, but similarly extend to beers, wines, and non-alcoholic beverages as well, including bottled water. Absent an appropriate system and method for monitoring internal liquor handling and dispensing practices, inventory and revenue losses will continue to occur at multiple operational levels, including shipping docks, inventory rooms, and bar fronts.

In an attempt to curtail inventory and revenue loss, certain available systems provide methods for determining pre-liquor and post-liquor volumetric and/or inventory quantities, the measurements of which may be subsequently compared to previously recorded inventory data to thereby detect any discrepancies, theft, and/or improper liquor dispensing or bartending practices. For instance, one such system offers bar code tracking technology, wherein each bottle of liquor, or the like, receives a bar code for tracking each bottle's final destination via wireless scanning devices. However, such a system fails to account for pre- and post-volumetric quantities—a core factor in determining revenue loss.

Accordingly, to remedy the foregoing pitfalls, other systems provide a method for weighing either individual or multiple bottles of liquor, and determining from pre- and post-use weights, the overall quantity of liquor dispensed during a specific period of time. The data of such determinations may thereafter be utilized for reconciliation of sales revenue generated during the selected period of time; thus, uncovering any discrepancies, if any. Although such weighing systems provide a degree of efficacy in determinations of inventory and revenue data, each such system requires that empty liquor bottles also be included in the weighing process. Unfortunately, empty bottles provide numerous loop-holes which may be used by immoral employees to “fool” the system and, thus, provide inaccurate measurements and data.

Additionally, most available systems are typically on-site systems, having an integral software component that may be operated in a backroom of the establishment; thus, subjecting the system to employee tampering and fabrication of inventory data. Accordingly, although remote or off-site data housing and processing systems would be preferred, the technological logistics for enabling real-time inventorying within a bar environment is seemingly absent from available systems. Further unaddressed by available systems, is a method for contemporaneously managing and inventorying the alcohol supply, distribution and dispensing of multiple, independent bars, clubs and restaurant.

Therefore, it is readily apparent that there is a need for an alcoholic beverage management and inventory system that provides an interactive system for monitoring and tracking alcohol from time of initial purchase, shipment, delivery to a shipping dock, transfer from the dock to an inventory or storage room, and distribution from the storage room to bar stations within an establishment. Once the liquor is distributed to the individual bar stations, there is a further need for such a system that tracks and monitors pre- and post-volumetric liquor quantities to thereby hold the bartenders accountable for improper dispensing practices. There is still a further need for such a system that may disregard empty alcohol bottles during weight measuring and inventorying processes and, thus, eliminate loop holes for potential error and/or employee deceptive practices.

### BRIEF SUMMARY OF THE INVENTION

Briefly described, in a preferred embodiment, the present invention overcomes the above-mentioned disadvantages and meets the recognized need for such an invention by providing an alcoholic beverage management and inventory system comprising a beverage bottle categorizing system; a weighing system for determining total liquor dispensed; a system for computing total profits earned or lost; a system and method for tracking the distribution and location of all bottles at any selected location within a bar establishment; and, an integrated data synchronization, transfer, processing, storage and retrieval system that enables real-time inventory management of any selected number of related and/or unrelated bar establishments.

According to its major aspects and broadly stated, the present invention in its preferred form is an alcoholic beverage management and inventory system, comprising an integrated network of handheld personal data assistants (PDAs), weighing scales, on-site customer computers (PCs), a main data center or server, and a central website, wherein inventory data uploaded and stored on the main server may be accessed via a global networking system (i.e., the Internet) through either the customer's PDAs or on-site PCs.

More specifically, the present invention is an alcoholic beverage management and inventory system, comprising a method for managing and categorizing beverage bottles based upon similarities between the beverages, such as average cost per unit weight; a weighing scale and system for calculating the weight of categorized liquor bottles at any selected time or interval (i.e., pre- and post-bartending shifts) to determine total liquor dispensed; a system for comparing total revenues to the cost of total liquor dispensed; a wireless handheld device for managing inventory data, for scanning and tracking the distribution and location of all bottles at any selected location within a bar establishment (i.e., shipping dock, inventory room, bar station, etc.), and for wirelessly receiving data from the weighing scale; and, a data synchronization and transfer system, and third-party database and network structure, for central data processing and archival data storage that enables real-time tracking, management and inventorying of alcohol supply and, thus, the monitoring of internal distribution and dispensing practices within multiple related, and/or multiple independent or unrelated, bars, bar stations, clubs and restaurants.

Accordingly, a feature and advantage of the present invention is its ability to accurately account for all liquor dispensed over a selected period of time and, thus, monitor and rectify inappropriate bartending practices.

Another feature and advantage of the present invention is its ability to track the distribution and location of all liquor bottles at any selected location within a bar establishment (i.e., shipping dock, inventory room, bar station, etc.).

Still another feature and advantage of the present invention is its provision of data synchronization and transfer processes, and a third-party database and network structure, for central data processing and archival data storage and real-time tracking, management and inventorying of alcohol supply.

Yet another feature and advantage of the present invention is its ability to enable the separate and discrete storage, management and analysis of all internal handling, distribution and dispensing practices of multiple related, or multiple independent or unrelated, bars, bar stations, clubs, restaurants, and/or the like.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a general flow diagram of an alcoholic beverage management and inventory system according to a preferred embodiment of the present invention;

FIG. 2 is a general flow diagram of an alcoholic beverage management and inventory system according to a preferred embodiment of the present invention;

FIG. 3 is an exemplary PDA screen shot of an alcoholic beverage management and inventory system according to a preferred embodiment of the present invention;

FIG. 4 is an exemplary PDA screen shot of an alcoholic beverage management and inventory system according to a preferred embodiment of the present invention;

FIG. 5 is an exemplary PDA screen shot of an alcoholic beverage management and inventory system according to a preferred embodiment of the present invention;

FIG. 6 is an exemplary PDA screen shot of an alcoholic beverage management and inventory system according to a preferred embodiment of the present invention;

FIG. 7 is an exemplary PDA screen shot of an alcoholic beverage management and inventory system according to a preferred embodiment of the present invention;

FIG. 8 is an exemplary PDA screen shot of an alcoholic beverage management and inventory system according to a preferred embodiment of the present invention;

FIG. 9 is an exemplary PDA screen shot of an alcoholic beverage management and inventory system according to a preferred embodiment of the present invention;

FIG. 10 is an exemplary PDA screen shot of an alcoholic beverage management and inventory system according to a preferred embodiment of the present invention;

FIG. 11 is an exemplary PDA screen shot of an alcoholic beverage management and inventory system according to a preferred embodiment of the present invention;

FIG. 12 is an exemplary PDA screen shot of an alcoholic beverage management and inventory system according to a preferred embodiment of the present invention;

FIG. 13 is an exemplary PDA screen shot of an alcoholic beverage management and inventory system according to a preferred embodiment of the present invention;

FIG. 14 is an exemplary PDA screen shot of an alcoholic beverage management and inventory system according to a preferred embodiment of the present invention;

FIG. 15 is an exemplary PDA screen shot of an alcoholic beverage management and inventory system according to a preferred embodiment of the present invention;

FIG. 16 is an exemplary PDA screen shot of an alcoholic beverage management and inventory system according to a preferred embodiment of the present invention;

FIG. 17 is an exemplary PDA screen shot of an alcoholic beverage management and inventory system according to a preferred embodiment of the present invention;

FIG. 18 is an exemplary screen shot of a website interface of an alcoholic beverage management and inventory system according to a preferred embodiment of the present invention;

FIG. 19 is an exemplary screen shot of a website interface of an alcoholic beverage management and inventory system according to a preferred embodiment of the present invention;

FIG. 20 is an exemplary screen shot of a website interface of an alcoholic beverage management and inventory system according to a preferred embodiment of the present invention;

FIG. 21 is an exemplary screen shot of a website interface of an alcoholic beverage management and inventory system according to a preferred embodiment of the present invention;

FIG. 22 is an exemplary screen shot of a website interface of an alcoholic beverage management and inventory system according to a preferred embodiment of the present invention;

FIG. 23 is an exemplary screen shot of a website interface of an alcoholic beverage management and inventory system according to a preferred embodiment of the present invention;

FIG. 24 is an exemplary screen shot of a website interface of an alcoholic beverage management and inventory system according to a preferred embodiment of the present invention;

FIG. 25 is an exemplary screen shot of a website interface of an alcoholic beverage management and inventory system according to a preferred embodiment of the present invention;

FIG. 26 is an exemplary screen shot of a website interface of an alcoholic beverage management and inventory system according to a preferred embodiment of the present invention;

FIG. 26A is an exemplary screen shot of a website interface of an alcoholic beverage management and inventory system according to a preferred embodiment of the present invention;

FIG. 27 is an exemplary screen shot of a website interface of an alcoholic beverage management and inventory system according to a preferred embodiment of the present invention;

FIG. 28 is an exemplary screen shot of a website interface of an alcoholic beverage management and inventory system according to a preferred embodiment of the present invention;

FIG. 29 is an exemplary screen shot of a website interface of an alcoholic beverage management and inventory system according to a preferred embodiment of the present invention;

FIG. 30 is an exemplary screen shot of a website interface of an alcoholic beverage management and inventory system according to a preferred embodiment of the present invention;

FIG. 31 is an exemplary screen shot of a website interface of an alcoholic beverage management and inventory system according to a preferred embodiment of the present invention;

FIG. 32 is an exemplary screen shot of a website interface of an alcoholic beverage management and inventory system according to a preferred embodiment of the present invention;

FIG. 33 is an exemplary screen shot of a website interface of an alcoholic beverage management and inventory system according to a preferred embodiment of the present invention;

FIG. 34 is an exemplary screen shot of a website interface of an alcoholic beverage management and inventory system according to a preferred embodiment of the present invention;

FIG. 35 is an exemplary screen shot of a website interface of an alcoholic beverage management and inventory system according to a preferred embodiment of the present invention;

FIG. 36 is an exemplary screen shot of a website interface of an alcoholic beverage management and inventory system according to a preferred embodiment of the present invention;

FIG. 37 is an exemplary screen shot of a website interface of an alcoholic beverage management and inventory system according to a preferred embodiment of the present invention;

FIG. 38 is an exemplary screen shot of a website interface of an alcoholic beverage management and inventory system according to a preferred embodiment of the present invention;

FIG. 39 is an exemplary screen shot of a website interface of an alcoholic beverage management and inventory system according to a preferred embodiment of the present invention;

FIG. 40 is an exemplary screen shot of a website interface of an alcoholic beverage management and inventory system according to a preferred embodiment of the present invention; and, FIG. 41 is flow diagram of the various steps employed in navigating through and utilizing the website software of an alcoholic beverage management and inventory system according to a preferred embodiment of the present invention; and, FIG. 42 is an exemplary bar closing report of an alcoholic beverage management and inventory system according to a preferred embodiment of the present invention.

### DETAILED DESCRIPTION OF THE PREFERRED AND ALTERNATIVE EMBODIMENTS

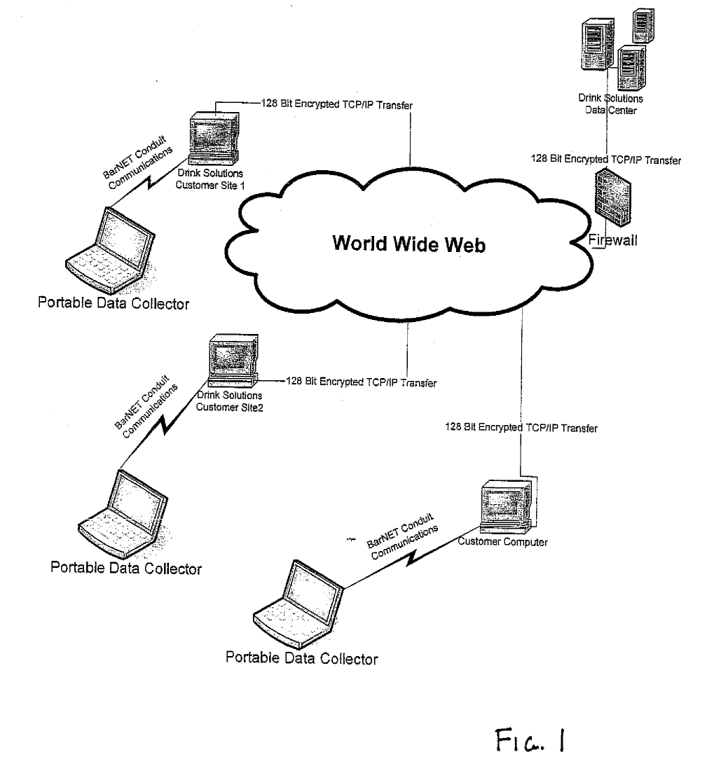

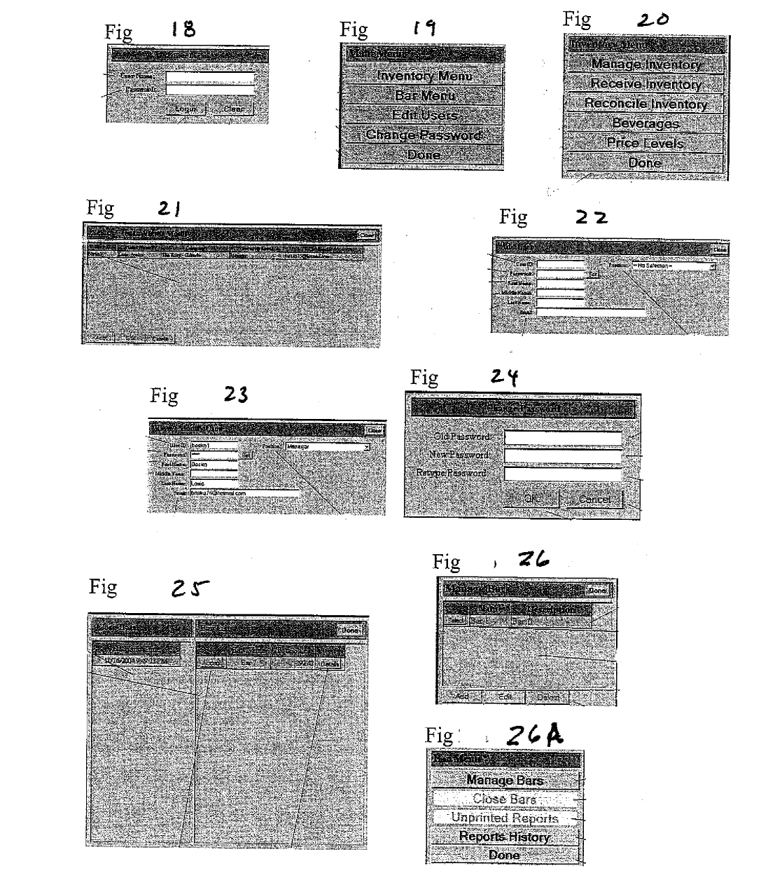

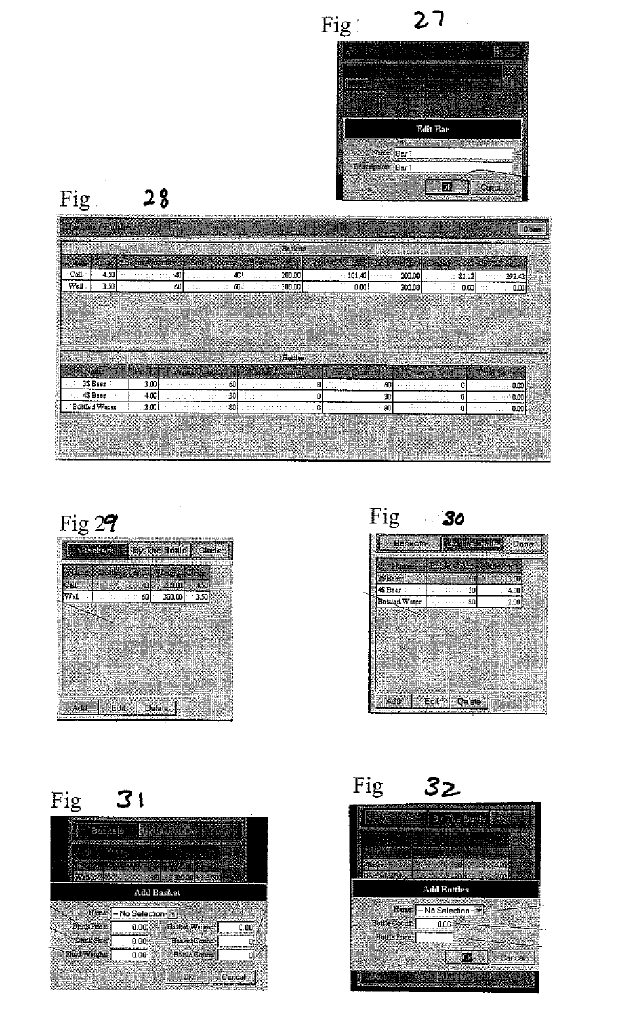

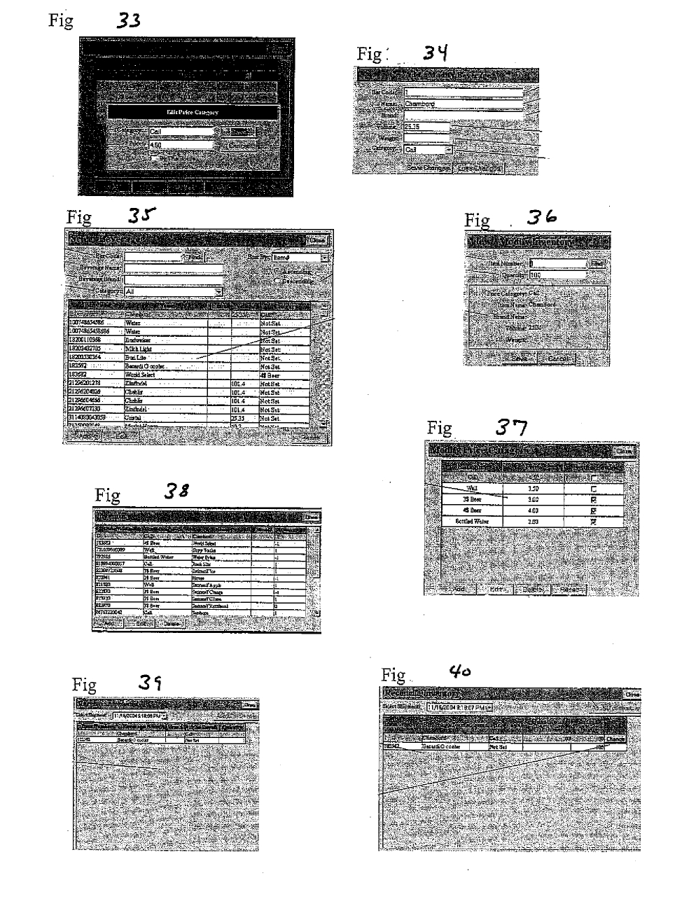

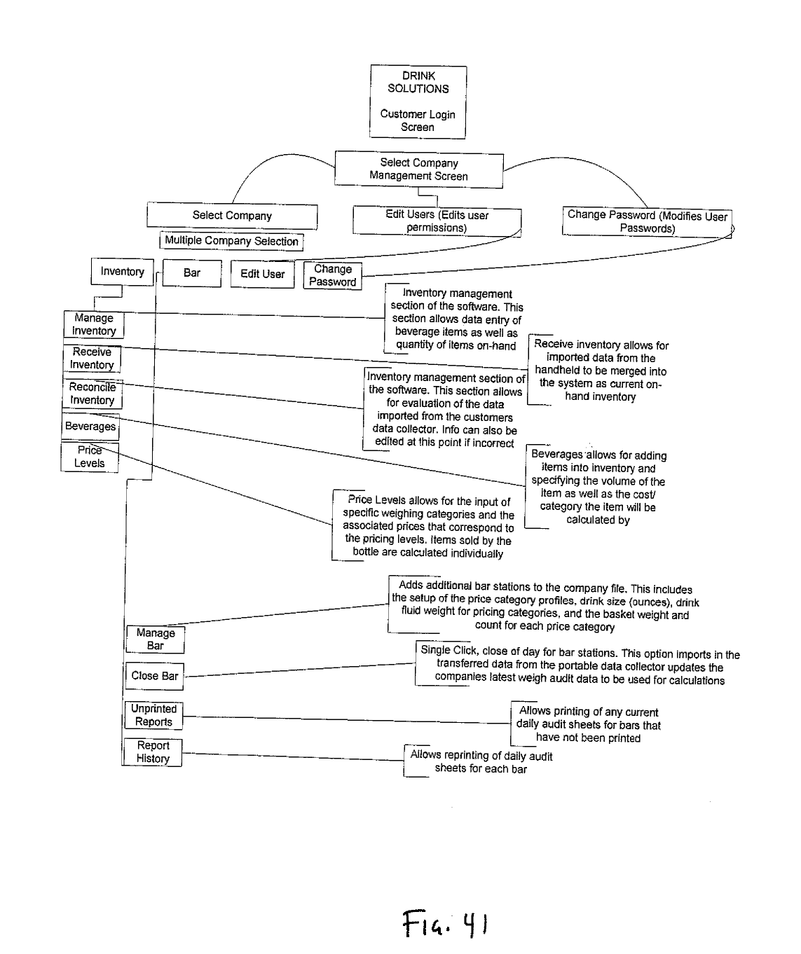

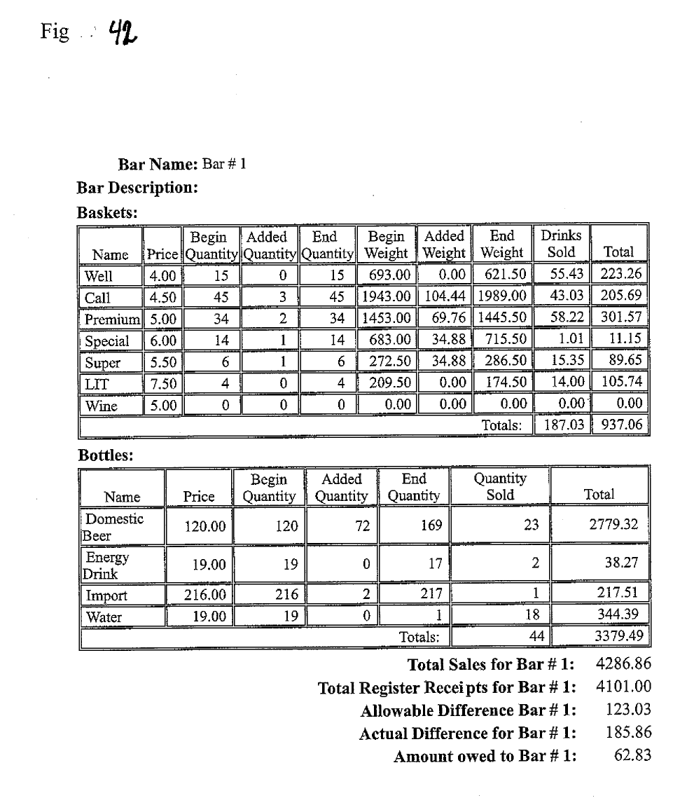

In describing the preferred and alternate embodiments of the present invention, as illustrated in FIGS. 1-42, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-2, the present invention in a preferred embodiment is an alcoholic beverage management and inventory system, comprising an integrated network of handheld personal data assistants (PDAs), weighing scales, on-site customer computers (PCs), a main data center or server, and a central website, wherein inventory data uploaded and stored on the main server may be accessed via a global networking system (i.e., the Internet) through either the customer's PDAs or on-site PCs. Preferably, the majority of the user's interaction with the main server is preferably afforded through the use of, and navigation through, various website interfaces illustrated in FIGS. 18-40, and more fully described hereinbelow. As such, it should be recognized that efforts toward system installation, configuration, use, and maintenance, as described hereinafter, are preferably coordinated or otherwise largely implemented through the central website, main server, and the associated software systems thereof.

Preferably, the present system and method is initiated by installing and configuring necessary software on the customer's PDAs and on-site PCs, and, thereafter, transferring data therebetween. Accordingly, the present invention contemplates the utilization of a synchronization (or “HotSync”) manager application, which will preferably reside on a computer at the customer's bar establishment (“onsite PC”—described hereinbelow). At the beginning of each shift, the synchronization program will retrieve information on all the bars, bartenders, inventory, and PDAs. Thereafter, the synchronization program will then prompt the user to synchronize each PDA. At the end of the night, the synchronization program will again prompt the user to synchronize each PDA and “close out” each bar. If needed, the synchronization program will allow a single bar, or multiple bars, to be “pushed” back to a PDA for purposes of re-weighing (as described hereinbelow). Once all of the bars are “closed out”, the synchronization program will combine the information from all bars into a single upload to an associated web site (described hereinbelow) for future access.

All information for the synchronization program will preferably be stored in an “access” database during the shift. However, when the synchronization program receives confirmation that the end of night upload was successful, the associated data table will be deleted (i.e, no data will be stored on the client's computer for more than the duration of a single shift). Although any suitable medium may be utilized, the present invention contemplates that the client will communicate with the web site through simple object access protocol (“SOAP”) services.

Each user (i.e., bar owner, manager, and the like) is assigned a login username and password to activate his account with the main server through his on-site PC (i.e., PCs located at the bar establishment), and thereby enable the uploading and downloading of inventory data thereto and therefrom, as more fully described hereinbelow. Following account activation, the user's login username and password is encrypted into his PDA; thereby, enabling the PDA to communicate with the main server.

Following full account activation, the user will then setup his online inventory by accessing the main server to download, from an extensive online database, a complete inventory list of all liquors and other beverages the bar establishment intends to sell. Each liquor or beverage type is preferably selected by name and placed within a category based upon product similarities, such as average cost per unit weight or serving size. For instance, all $4.00/drink vodkas would be categorized with all other $4.00/drink liquors (ex., wells, calls, premiums, super-premiums, and the like). Each such liquor and/or beverage brands to be sold by the establishment are preferably identified, categorized and added to the establishment's online inventory list in such a manner; thereby, building a plurality of pricing categories that will be utilized during the weighing process to compute the overall cost of total liquor dispensed.

After each liquor and/or beverage brand has been categorized, the user preferably synchronizes his PDA with his PC and, thus, downloads onto his PDA a complete inventory list of all liquors and/or beverages offered by the bar establishment, along with associated vendor's/manufacturer's bar codes for each bottle. Accordingly, through the bar code label of each bottle, the present system can provide the brand, initial weight and volume of each bottle, and pricing category (as designated by the user).

Thereafter, each bar station of the establishment is assigned a number through the PDA. Assigning each bar station a number preferably functions to separate and monitor the activity of each individual bartender, holding each accountable for unacceptable dispensing and bartending practices as reflected in the results of final inventory computations. Further, assigning each bar station a number enables the user to assign a destination to each bottle removed from the stock room, and trace same to the assigned bar station during reconciliation of inventory behind each bar station, as more fully described hereinbelow.

Following numeration of each bar station, all liquor and beverage bottles and cases contained within the stock room are preferably counted (or otherwise scanned by the PDA) and the results inputted into the user's PDA. Then, all liquor and beverage bottles and cases contained behind each bar station are counted, and the results for each bar station are inputted into the PDA under the respectively numbered bar station. In addition to counting all the liquor and beverage bottles/cases of each bar station, all liquor and beverage bottles behind each bar station are placed in weigh baskets, according to commonly designated pricing categories, and weighed to yield pre-shift or starting weights. Similarly, all bus tubs are labeled according to their price category and with the corresponding bar code. The bar code will be scanned with the PDA, wherein the software will recognize the price category of the bus tub. The bus tub is then weighed and the data is recorded under the correct price category.

Preferably, the foregoing weighing step is performed by the owner or manager of the establishment, so as to shield the initial data and liquor weights from employees that might otherwise tamper with same to accommodate for theft or anticipated theft during the employees' shifts.

The weighing system of the present invention preferably wirelessly transfers all weight values and data directly to the user's PDA. Following the foregoing steps, the owner or manager preferably synchronizes his PDA with the on-site PC, wherein all data may then be uploaded to the main server for future inventory tabulations, pending close-out of the bar establishment. Alternatively, the owner/manager may synchronize his PDA data directly with the main server. This foregoing step is further shielded from other employees to reduce tampering or fraud.

Additionally, the present invention contemplates the process of assigning density and total weight of a full bottle of liquor for each brand/type/volume of liquor. This process calculates total liquor usage by taking into consideration different liquor densities. As such, in order to calculate liquor usage for each price category, average density of all liquors in each price category needs to be established. Consequently, total full bottle weight information is needed for each liquor brand, type and volume, and changes to same. With total bottle weight and density for each bottle known, the present system enables a user to keep track of any differences in glass weight of the bottles being exchanged and/or scanned in from bar to stockroom, or form bar-to-bar, or the like.

During new deliveries to the stockroom, when a new bottle of liquor/beverage is scanned with the PDA, and it is determined that the new bottle is not in the present inventory, a prompt reading “Do you whish to add this item?” is displayed on the PDA screen. Selecting “yes” on the PDA screen enables the user to add/edit the beverage information through an interactive window on the PDA, wherein the following information may be entered: price category, name, brand, volume, weight, density, and total bottle weight.

Any and all shipments received during the business day are preferably scanned-in via the PDA, wherein such scanning processes may be done by the case, or by the bottle depending upon the content of the particular shipment. Regardless, the present system recognizes each liquor or beverage bottle via the associated bar code, and inventories same in the pre-assigned pricing categories established by the user. Thereafter, the user may then synchronize his PDA with his PC, and then upload all data to the main server; thus, updating the online inventory count to reflect all bottles currently on the establishment's premises, and ensuring that all new shipments or deliveries are accounted for during the close-out inventorying process. The shipment inventorying process may be implemented at the establishment's shipping bay and/or stock room, and is further preferably conducted by the owner or manager of the establishment; thereby, avoiding potential employee theft of product and/or tampering with inventory data.

Additionally, the present invention utilizes a delivery bottles price input function as a necessary step to acquire data used to calculate percent liquor cost. With every new delivery to an establishment, be it liquor, beer, etc., cost per unit needs to be recorded. The present recording system is flexible and, as such, take into account that the cost of the same product may vary from time to time—for instance, as a result of different deals made according to quantity or seasonal specials. Establishing this difference is necessary for calculating exact liquor cost percentage.

Accordingly, as the delivery quantities are being scanned into inventory with the PDA, a prompt for each item's unit cost will display on the PDA screen, wherein price per item for the delivery may then be entered. The selected price will only be used for the number of units for that particular delivery.

Every bottle that leaves the stock room during any particular bartending shift is preferably scanned by the user's PDA to assigned and record the destination of same to a numbered bar station. Additionally, by virtue of the bar code information of each bottle, the pre-use weight and volume of each bottle is known (whether a new bottle, or a used bottle for which weight and volume were previously calculated utilizing the present system and method, as described hereinbelow). Accordingly, because each bottle is scanned prior to leaving the stock room, a perpetual inventory of all bottles distributed to each specifically numbered bar station is provided, as is the weight and volume of each such bottle so distributed; thereby, further enabling accurate post-shift or close-out inventorying calculations. Furthermore, scanning each bottle prior to removal from the stock room functions to prevent and/or track stock room theft. That is, if a bottle is scanned and removed from the stock room, but fails to be delivered to the assigned bar station, such a deficiency will be reflected in the post-shift or close-out inventorying calculations of the respective bar station; thus, holding the bartender accountable. If a bottle is removed from the stock room without being scanned, such a deficiency will be reflected in stock room inventorying calculations; thus, holding managers or stock room personnel accountable.

Moreover, so as to eliminate a possible loop-hole in which to cheat the system, all empty bottles are discarded by the bartenders; thus, eliminating the possibility of filling the bottle with water or other foreign liquids to accommodate for unacceptable liquor loss. However, in handling empty bottles, an empty bottle is preferably first scanned out, and a full bottle of the same beverage scanned in. However, with outright bottle sales, there are no empty bottles to be scanned out. As such, the present system, as described hereinbelow, simply requires that the bottle be scanned in via the PDA.

Scanning out empty bottles (for purposes of enabling delivery of full bottles to bar stations) is necessary for two particular reasons. The first reason is that the number of new/full bottles delivered to a bar station has to equal the number of empty bottles scanned and discarded at that particular bar station (i.e., before a full bottle can be delivered to a bar station, an empty bottle that is going to be replaced with the new bottle needs to be scanned into the PDA). The foregoing step preferably maintains the integrity of bar pars. The second reason is that, if there are any changes in liquor brands used, the system will track the differences in density, glass weight, and volume.

During the post-shift or close-out inventorying process specific to each bar station, all liquor and beverage bottles behind each bar station are counted, placed in weighing baskets according to commonly designated pricing categories, and weighed to yield post-shift or ending weights. Unlike pre-shift weighing procedures, the foregoing post-shift weighing procedure may be performed by general employees or bartenders, as such individuals do not know what the pre-shift or starting weight/volume was and, thus, what the post-shift or ending weight/volume needs to be. Notably, all beers, water, and other beverages sold only by the bottle, are preferably counted individually. Such beverages are added to a bar station by the case, and are only replenished when the case is emptied. All unused potions of the case are taken into consideration during post-shift inventory calculations. The weighing system preferably wirelessly transfers all post-shift weight values and data directly to the user's PDA, wherein all such data is preferably uploaded to the main server.

After all containers or baskets for each bar station are weighed, they are locked and placed atop the bar counter to prevent tampering. Prior to beginning the next shift, a bartender may request that each container be weighed so as to verify the weight and uncover any possible post-shift tampering.

With regard to closing-out and inventorying the stock room, all bottles scanned and removed from the stock room need to be accounted for and reconciled with the post-shift counts of each bar station; thereby, tabulating total inventory remaining in the stock room, and determining any inconsistencies between pre- and post-shift weights/counts of bar station inventory and stock room inventory. All data is thereafter uploaded to the main server.

Following all close-out inventory procedures, the user may access the central website to input each individual bartender's sales receipts for a particular shift or series of shifts. The web-based software of the present system then compares all pre-shift and post-shift weight values and bottle/case counts, and tabulates, based on pricing category, total cost of liquor dispensed. The total cost of liquor dispensed is then compared to total sale receipts for each bartender over a particular shift or series of shifts; thereby, reflecting any discrepancies between total cost of liquor dispensed and total sales. As more fully described hereinbelow with reference to FIG. 42, a printable report is further produced at the user's election.

Referring now more specifically to the computations of the present system, the basic equation utilized for each price category to determine total liquor dispensed over any given inventory period, at any particular bar station, is as follows:
(pre-shift or starting weight of bottles at bar station)+(weight of all bottles removed from stock room and delivered to bar station during shift)−(post-shift or ending weight of all bottles at bar station)=total ounces liquor dispensed over shift period.

Specifically, the “pre-shift or starting weight of bottles at bar station” variable is equal to the post-shift weight from the last inventory calculation (i.e., previous night); the “weight of all bottles removed from stock room and delivered to bar station during shift” variable includes all liquor bottles scanned-out from the stock room and assigned to a specific bar station (added in real-time via the user's PDA); and, the “post-shift or ending weight of all bottles at bar station” variable is equal to the combined ending weight of all bottles behind the bar station at the end of the shift, including those received from the stock room. Notably, the “total ounces liquor dispensed over shift period” is not a measure of total volume of liquor dispensed, as the density of each type of liquor differs. Additionally, although not reflected in the above equation, the weighing baskets are constants; thus, the same number of weighing baskets utilized during pre-shift weighing procedure is also utilized during post-shift weighing procedure.

In addition to the foregoing equation, the average density per shot in each pricing category must further be calculated. Accordingly, for every bottle within a certain pricing category, the following equation is preferably utilized:
(Total weight of bottle/Total volume of bottle)×(Volume of a shot)=Shot weight in ounces
wherein:
(Average shot weight for a pricing category) =(Sum of shot weights for all bottles/total number of bottles).

Accordingly, from the above equations, the total amount of revenue a particular bar station should have earned over a selected shift may be calculated as follows:
((total ounces liquor dispensed over shift period)/(Shot weight in ounces))×(Price per shot in applicable pricing category)=Total revenue earned.

Similarly, the total amount of revenue a particular bar station should have earned over a selected shift for “by the bottle sales” (i.e., beer, water, energy drinks, etc.) may be calculated as follows:
(Initial bottle count—ending bottle count) ×(Price per bottle)=Total revenue earned.

Finally, the total shortage may be calculated in terms of percentage as follows:
((Total revenue losses)/(Total revenue earned))×100 =Percentage of revenue lost.

Application of the foregoing equations are best illustrated with reference to FIG. 42, which depicts a bar closing report. Specifically, the report of FIG. 42 delineates the variables of the foregoing equations as applied to various pricing categories for various baskets, and for beverages sold “by the bottle,” and further provides calculations for total sales receipts, total liquor dispensed, total revenues lost, and the like. Notably, the report takes into consideration an “allowance” or acceptable margin of error in bartending practices. Such an “allowance” may be factored into the foregoing equations as either a constant or variable depending upon pricing category, price adjustment during selected shifts, and the like.

Referring now more specifically, to FIGS. 3-17, illustrated therein are exemplary PDA screen shots encountered by the user in navigating and utilizing the present system and method, as described hereinabove. With specific reference to FIG. 3, the “main menu” enables the user to: access the “manage bar” function for inputting or editing data specific to a bar station; access the “receive shipment” function for adding new deliveries and shipments to the existing inventory; access the “reconcile inventory” function for use during removal and scanning of bottles from the stock room, and assigning same to a particular bar station; and, access the “quit” function to log-out of an inventory session.

With specific reference now to FIG. 4, the “manage bars” menu enables the user to: access all listed or numbered bar stations within the establishment; access the “baskets” function to view current pricing categories for each weighing basket, and the total number of baskets that were utilized in a particular pricing category during the last inventory check; and, access the “bottles” function to view the total number of bottles of beer or other beverages sold “by the bottle.”

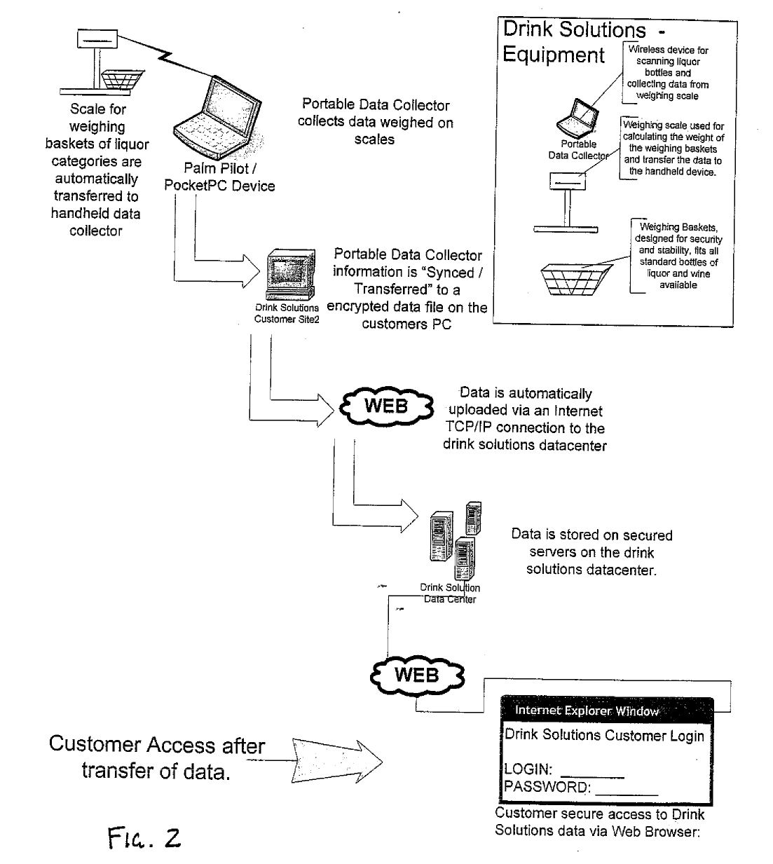

With specific reference now to FIG. 5, the “manage bars-basket” menu enables the user to: view all price categories of liquors housed in, or otherwise assigned to, a particular bar station; access the “add” function to add a new pricing category; access the “return function” to record the return of an erroneously-pulled bottle back to the stock room; access the “close baskets” function to close-out baskets and enter post-shift or ending weights; access the “details” function to view all data relevant to a particular pricing category; and, access the “go to bottles” function to view all current baskets.

With specific reference now to FIG. 6, the “manage bars-bottles” menu enables the user to manage all liquor bottles and all beverages sold “by the bottle”. Specifically, the “manage bars-bottles” menu enables the user to: view a list of all bottled beverages for sale and sold; access the “add” function to add a bottled beverage to the inventory list; access the “close bottles” function to enable the user to enter post-shift bottle count of a particular bar station; access the “details” function to view all data concerning all bottles that have been accounted; access the “go to baskets” function to view all currently managed baskets; and, to view all UPC bar codes for each scanned bottle.

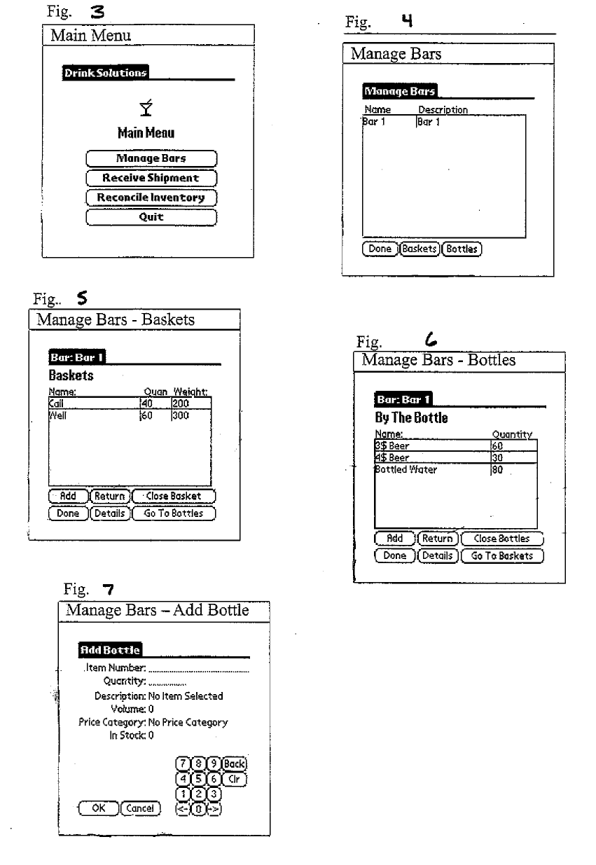

With specific reference now to FIGS. 7-8, the “manage bars-add bottle” and “manage bars-return” menus, respectively, enable the user to record the addition or return of bottles to the stock room. Specifically, the foregoing menus enable the user to: input all quantities of bottles added or returned to the stock room; view the brand name of liquor following UPC bar code recognition of each scanned bottle; view the volume of liquor for each such scanned bottle; view the pricing category of each scanned bottle; access the “cancel” function to delete selected data; and, manually input bottle count.

With specific reference now to FIG. 9, the “manage bars-details” menu enables the user to view the details of all liquor bottles behind a particular bar station. Specifically, the “manage bars-details” menu enables the user to: view starting quantities of bottles behind a particular bar station; view starting weights of bottles behind a particular bar station; view detailed brand and volume information for each bottle behind a particular bar station; view current bottle count behind a particular bar station; and, view ending weight of all bottles behind a particular bar station.

With specific reference now to FIG. 10, the “manage bars-close basket” menu enables the user to input the weight from each basket weighed, in each pricing category. Specifically, the “manage bars-close basket” menu enables the user to: view all baskets that need to be weighed prior to close-out; input and add data particular to each basket being weighed; view the starting weight of each basket; view the ending weight of each basket; view the starting count of each basket; and, view the ending count of each basket.

With specific reference now to FIG. 11, the “manage bars-close bottles” menu enables the user to input for each bar station the total count of bottles sold “by the bottle.” Specifically, the “manage bars-close bottles” menu enables the user to: input and view all starting counts of all individual bottles behind a particular bar station; and, input and view all ending counts of all individual bottles behind a particular bar station.

With specific reference now to FIG. 12, the “receive shipment-add item” menu enables the user to enter into the PDA all liquor received by the bottle or case. Specifically, the “receive shipment-add item” menu enables the user to: scan all received bottles individually or by the case, and view the associated UPC bar codes; easily add multiple bottles of the same liquor; view the brand and product name of all scanned bottles; view the quantity of all scanned bottles; access the “add” function to add the total count of newly received bottles to the previous inventory count of the stock room; and, select the “auto” option to enable simultaneous scanning of multiple bottles or cases delivered.

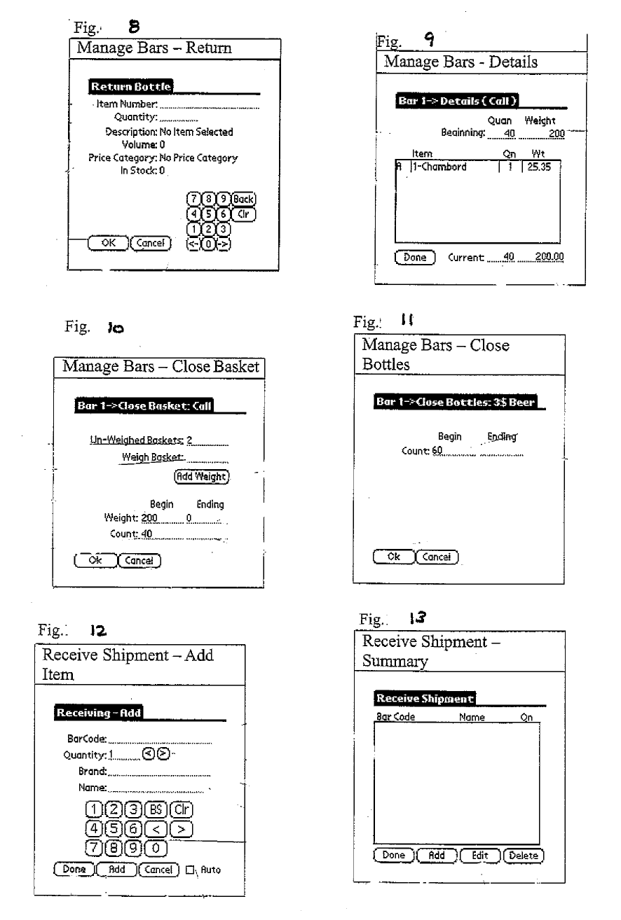

With specific reference now to FIG. 13, the “receive shipment-summary” menu enables the user to: view a detailed list of all deliveries made during a particular day or shift; access the “add” function to add additional shipment quantities or information; and, access the “delete” function to delete any erroneously entered shipment data.

With specific reference now to FIG. 14, the “receive shipment-edit item” menu enables the user to: edit shipment data (i.e., brand, quantity, etc.) by the bottle or case; and, view applicable UPC bar code for each edited bottle/case. Similarly, the “receive shipment-delete item” menu, best illustrated in FIG. 15, enables the user to delete any erroneously entered shipment information.

With specific reference now to FIG. 16, the “reconcile inventory-summary” menu enables the user to: view all liquor scanned-out and removed from the stock room during a particular shift, and the bar station to which the liquor was assigned; access the “add” function to add or assign a bottle to a specific bar station; access the “edit” function edit data for any assigned bottle of any bar station; and, access the “delete” function to delete any erroneous information entered during reconciliation.

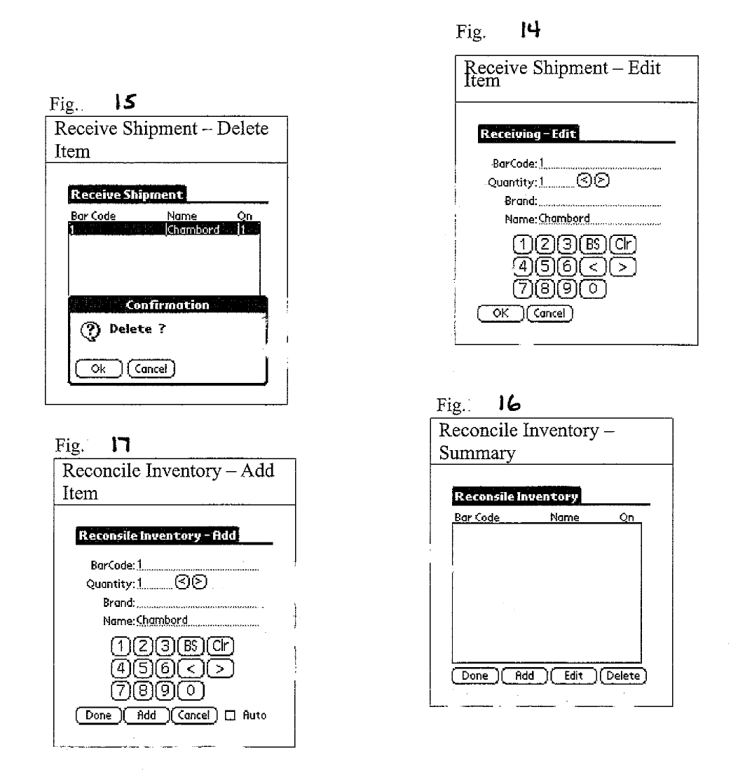

With specific reference now to FIG. 17, the “reconcile inventory-add item” menu enables the user to: add or input liquor data that needs to be reconciled with a particular bar station; view all applicable UPC bar codes and product information for all bottles scanned-out and removed from the stock room; input the amount of bottles assigned and delivered to a particular bar station; access a “keypad” to enter UPC bar code information; access an “add” function to add a bottle to a particular bar station; access a “cancel” function to delete selected data; and, select the “auto” option to enable simultaneous scanning of multiple bottles or cases during reconciliation of a bar station.

With regard to all PDA screen shots illustrated in FIGS. 3-17, it should be recognized that the options and functions available through each such screen are not so limited to the above disclosures. Accordingly, it should be recognized that each screen comprises, or may selectively comprise, without limitation, “edit”, “add”, “delete”, “return to previous screen” and/or “cancel” functions to facilitate use of the present system and method.

Referring generally now to FIGS. 18-40, illustrated therein are exemplary screen shots of website interfaces encountered in navigating through and utilizing the software system of the present invention. Additionally, FIG. 41 illustrates a flow diagram of the various steps employed in, and the resulting functions of, navigating through and utilizing the present software system. As described hereinabove, the present website and associated software enables the user to interface with the main server and, thus, setup initial online inventories, manage inventories, receive and reconcile inventories, set pricing categories, manage bars, develop printable reports, and access and utilize all other available functions of the present invention as set forth herein.

The present software system and method provides exceptional advantages over conventional local area network (LAN) environments, which are often characterized by costly setup, costly hardware, dependency upon networked trained personnel setup, dependency upon networked trained personnel support, dependency upon local network support, dependency upon local backup of data, and hardware and/or software failure and associated downtime. Accordingly, the present system and method seeks to remedy the disadvantages of conventional LAN systems by minimizing the cost of hardware and software ownership and maintenance, and by maximizing the flow of information, the security and speed of processing, and the speed of implementing enhancements and features in accord with industry change.

Specifically, the present software system may be categorized as a wide area network (WAN) solution, because regardless of whether the user has a single on-site PC or multiple on-site PCs, the present software system operates independently of the user's hardware equipment. That is, all processing software and data is stored on the main server, in a remote or off-site location, and accessible by the user via the Internet. As such, regardless of the age of the user's PC hardware, the present software will operate equally as efficient as if run on an expensive or up-to-date computer network.

Still, the present system, and more specifically the provider thereof, may be categorized as an application service provider (ASP), as the provider of the present system would house, support and maintain the application without any intervention required on the user's behalf. Accordingly, all installations, upgrades, backups and support services are handled by the service provider; thereby, minimizing otherwise costly hardware, personnel, and services for ongoing computer upgrades and software support.

As described hereinabove, the present system comprises three primary components: a PDA for recording and storing beverage data from the user's establishment, and for transferring the data to the main server for processing and analysis by the service provider of the present system; a software application or conduit, which is the only piece of software installed on the user's local PC(s), and which enables the PDA to synchronize data with the user's PC for transfer to the main server via TCP/IP technology; and, a web portal/application data server, which is the main server of the present invention that operates or runs the present software and databases referred to hereinabove, and which provides secure access to each user's account upon entry of accurate login information, as described hereinabove. Notably, the main server of the present invention routes each user's PDA to the specific uses configuration of data; thereby, providing secure access for each user to see only his own data through any computer providing Internet access.

Accordingly, the main server of present system may be configured to administer multiple user sites and separately store and manage all respective business data for each separate user; thus, enabling the separate and discrete storage, management and analysis of all internal handling, distribution and dispensing practices of multiple related, or multiple independent or unrelated, bars, bar stations, clubs, restaurants, and/or the like. As such, associated or dedicated website portals preferably enable only authorized users' to access their respective business data through the main server, whilst maintaining other users' information strictly confidential.

In accordance with the provision of multiple user sites, the present invention ensures that each PDA comprises a unique identification code that must match a valid DIC code on the service provider's administration page particular to the user's account (i.e., the DIC code is a code generated number that the present software system creates on the main server side). Accordingly, during the PDA synchronization process, if the main server does not recognize the PDA identification code, then the synchronization process is terminated. If the PDA identification code is recognized, however, then it is associated with a particular user, wherein the server then ensures that the synchronization process is being performed through an IP address that is approved for that particular user. If the IP address is approved, then the PDA is authenticated and the synchronization process continues. If the IP address is not authorized, however, then the synchronization process terminates.

The present system further provides network-level clearinghouse functions, wherein data management may be conducted through the software application or conduit installed on the user's PC(s) and, thereafter, transferred to the main server upon synchronization, or manually inputted upon access to the user's account via appropriate login information.

Still further, the present system provides and administers network-level security. That is, all data synchronized through the user's PC application is encrypted and interpreted by the main server only after the transfer is complete. All data sent or received by the main server must originate from an authenticated DIC keycode stored on the user's PDA and associated with the user's account on the main server. As described hereinabove, all users must utilize appropriate login information when accessing their respective accounts, wherein the present system may thereafter limit synchronization processes to specific IP addresses for further security purposes.

The present system yet further provides or administers network level beverage library/database updates. Specifically, the beverage database is shared across, and accessible to, all user accounts. As such, when a user enters new beverage information, that beverage information is now immediately available as an inventory listed item that other users may select when building their online inventory, as described hereinabove.

Another feature of the present system is its administration of network level protocols for beverage ordering processes; thus, providing a comprehensive product ordering and fulfillment service. That is, the present invention seeks to standardize beverage ordering processes between the customer/user and the vendor or distributor by setting reporting parameters within the user's account that automatically detects or extracts data indicative of low stock quantity items (i.e., by vendor name and liquor type) and, thereafter, generates an order file or request that may be emailed and/or faxed to the appropriate vendor/distributor for fulfillment of the order.

The present system still further administers procedures and protocols for data storage and transfer by ensuring redundancy of data storage, backups, and nearly constant service uptime, and by ensuring that all data traffic utilizes the “http” protocol, that all data transmission consist of “XML” data, and that all data is stored in a MS SQL server database directly linked to the main server.

Additionally, the present system further houses data points from synchronization-to-synchronization. That is, during the synchronization process, the present system creates a temporary file on the desktop of the user's PC through which the data is being transferred. The temporary file is preferably in an encrypted format, and is preferably removed from the user's desktop once the data transmission is verified by the main server.

The present system still further provides or administers reporting, tracking and archival procedures for all data and historical information. As such, although users may elect to print single daily reports after the close of business, the present system provides statistical analyses based on archived historical data and, thus, associated reports that may be used to forecast financial dispositions of the user's company, and/or forecast and track inventory depletion and ordering trends.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. An alcoholic beverage management and inventory system, comprising:
a beverage bottle categorizing system;
a weighing system for determining total liquor dispensed;
a system for computing total profits earned or lost;
a system and method for tracking the distribution and location of all bottles at any selected location within a bar establishment; and,
an integrated data synchronization, transfer, processing, storage and retrieval system that enables real-time inventory management of any selected number of related and/or unrelated bar establishments.
